(19) United States
(12) Patent Application Publication
(10) Pub. No.: US 2024/0329397 A1
(43) Pub. Date: Oct. 3, 2024

(54) DISPLAY DEVICE

(71) Applicant: Panasonic Automotive Systems Co., Ltd., Kanagawa (JP)

(72) Inventors: Yukihiro CHOKYU, Osaka (JP); Hiroki HARA, Osaka (JP); Akira KUROZUKA, Osaka (JP); Nobuhiko SASAKI, Kanagawa (JP)

(73) Assignee: Panasonic Automotive Systems Co., Ltd., Kanagawa (JP)

(21) Appl. No.: 18/608,189

(22) Filed: Mar. 18, 2024

(30) Foreign Application Priority Data
Mar. 31, 2023 (JP) 2023-057601

(51) Int. Cl. G02B 27/01; B60K 37/20; G02B 27/28; G02B 27/30

(52) U.S. Cl. CPC G02B 27/0103; B60K 37/20; G02B 27/285; G02B 27/30; B60K 2360/29; G02B 2027/0105

(57) ABSTRACT

A display device includes a light guide plate including a hologram element and a light emitter that emits light to the light guide plate. In addition, the light emitter includes a light source that emits light, and a first optical body including a plurality of first lenses capable of adjusting a contour of the light emitted by the light source. An outline of each of the plurality of first lenses is analogous to a shape of the hologram element.

### CROSS REFERENCE TO RELATED APPLICATION

The present application is based on and claims priority of Japanese Patent Application No. 2023-057601 filed on Mar. 31, 2023.

### FIELD

The present disclosure relates to a display device.

### BACKGROUND

Patent Literature (PTL) 1 discloses a virtual image projection device including: a light source that emits light; a microlens array that emits the light emitted from the light source as light with a predetermined angular distribution; an imaging lens that focuses the light from the microlens array; a display that is illuminated by light focused by the imaging lens to generate an image, a projector that projects the image generated by the display as image light, and a light guide that guides the image light projected from the projector.

### CITATION LIST

### Patent Literature

PTL 1: Japanese Unexamined Patent Application Publication No. 2021-189293

### SUMMARY

### Technical Problem

The optical device according to PTL 1 can be improved upon.

In view of this, the present disclosure is capable of improving upon the above related art.

### Solution to Problem

A display device according to an aspect of the present disclosure includes: a light guide plate including a hologram element; and a light emitter that emits light to the light guide plate, wherein the light emitter includes: a light source that emits light; and a first optical body including a plurality of first lenses capable of adjusting a contour of the light emitted by the light source, and an outline of each of the plurality of first lenses is analogous to a shape of the hologram element.

### Advantageous Effects

A display device and the like of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1A is a schematic diagram showing an example of a vehicle in which a display device according to an embodiment is installed.

FIG. 1B is a schematic diagram showing the display device according to the embodiment and the vehicle viewed in the right direction.

FIG. 2 is a perspective view showing the display device according to the embodiment.

FIG. 3 is a diagram showing the display device according to the embodiment.

FIG. 4 is a diagram showing the internal configuration of the light emitter.

FIG. 5 is a perspective view of the first optical body.

FIG. 6 is a side view showing the first lens of the first optical body.

FIG. 7 is a perspective view of the second optical body.

FIG. 8 is a cross-sectional view of the second optical body.

FIG. 9 is a diagram showing the state of light emitted from the first optical body when the first light source and the second light source are arranged side by side.

FIG. 10 is another diagram showing the state of light emitted from the first optical body in the arrangement where the direction of light emitted by the first light source and the direction of light emitted by the second light source are different.

### DESCRIPTION OF EMBODIMENT

Hereinafter, embodiments will be specifically described with reference to the drawings.

It should be noted that all embodiments described below show comprehensive or specific examples. The numerical values, shapes, materials, components, arrangement positions and connection forms of the components, steps, order of steps, and the like shown in the following embodiments are examples, and are not intended to limit the present disclosure. In addition, among the components in the following embodiments, the components not described in the independent claims are described as arbitrary components.

In addition, each figure is a schematic diagram and is not necessarily exactly illustrated. In addition, in each figure, the same reference numerals are attached to the same components.

In addition, in the following embodiments, expressions such as rectangular-shaped, approximately parallel, and right direction are used. For example, rectangular-shaped, approximately parallel, and right direction not only mean completely rectangular, parallel, and right direction, but also substantially rectangular, parallel, and right direction, that is, it also means that it includes errors of about several percentages. In addition, rectangular-shaped, approximately parallel, and right direction mean rectangular, parallel, and right direction within the range where the effects of the present disclosure can be achieved. The same also applies to such a case that other expressions using “shaped” and “approximately” exist.

### Embodiment

### <Configuration>

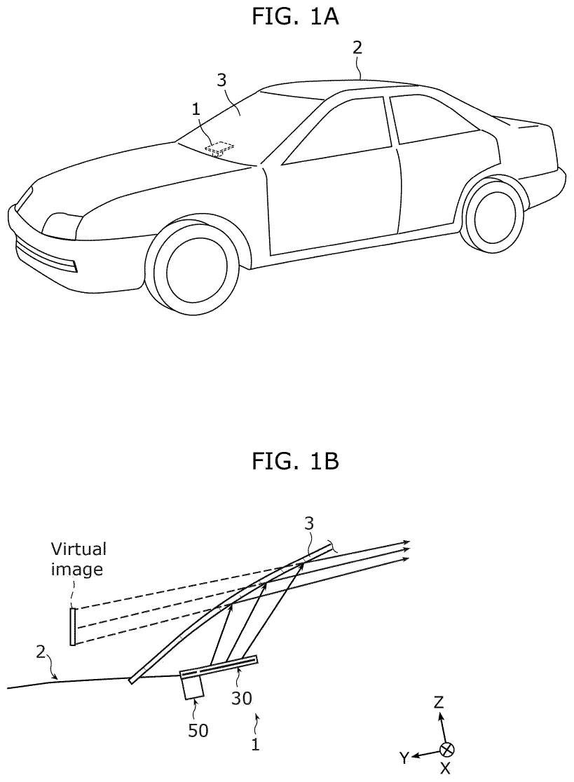

First, the configuration of display device 1 will be explained with reference to FIG. 1A to FIG. 10.

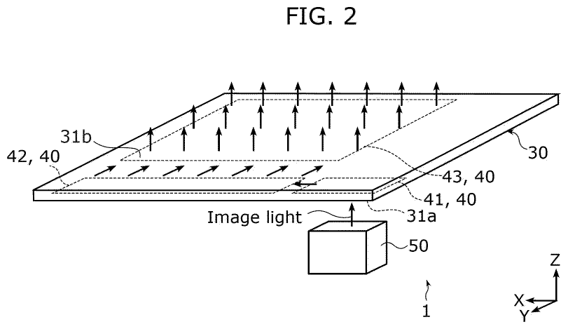

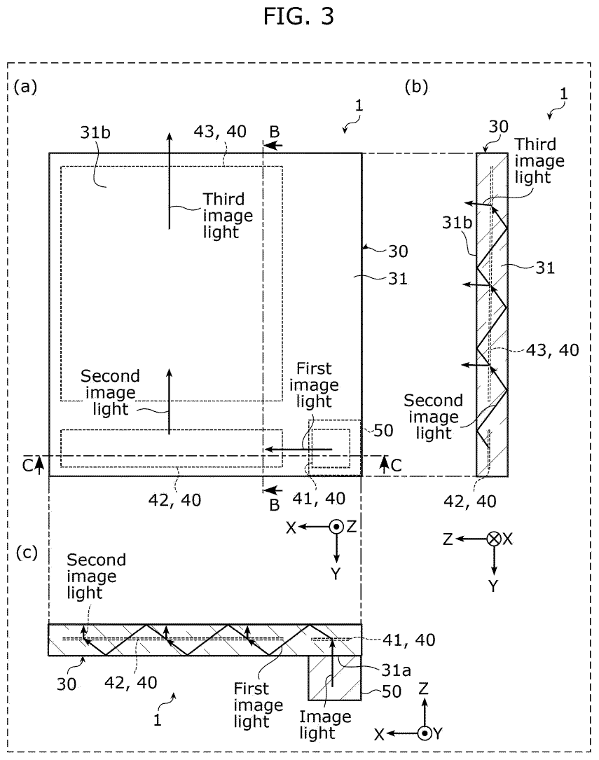

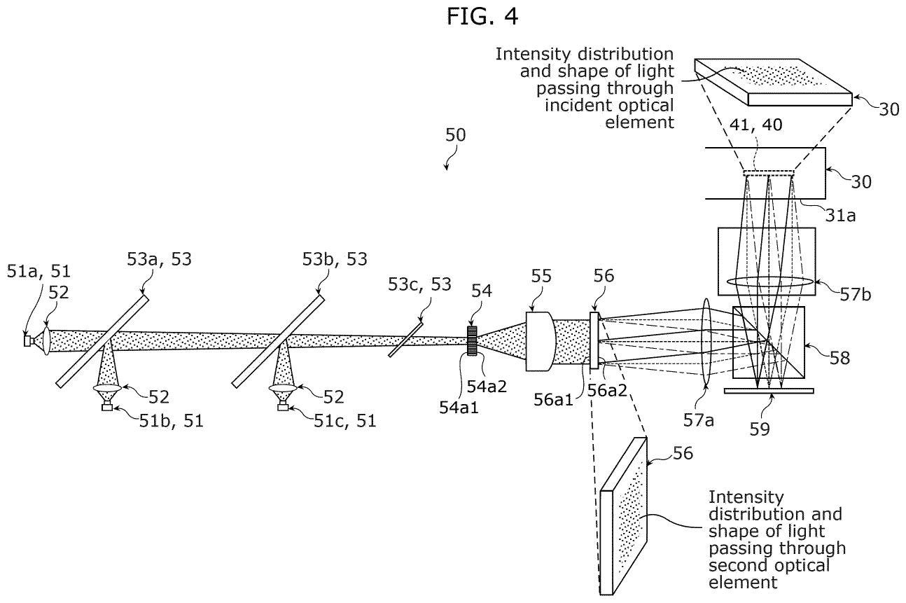

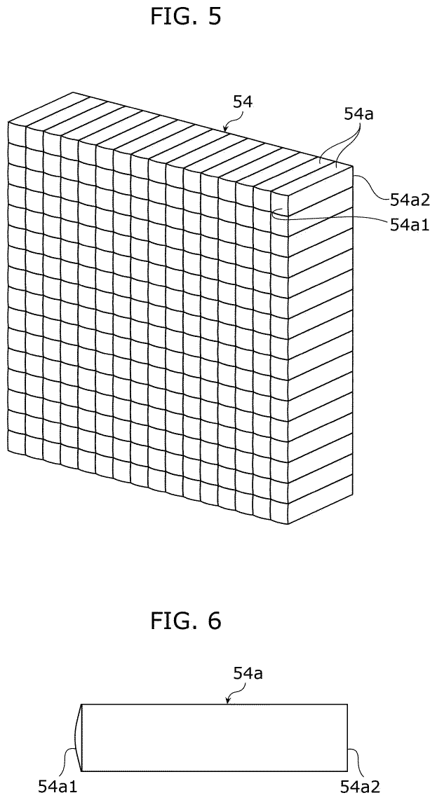

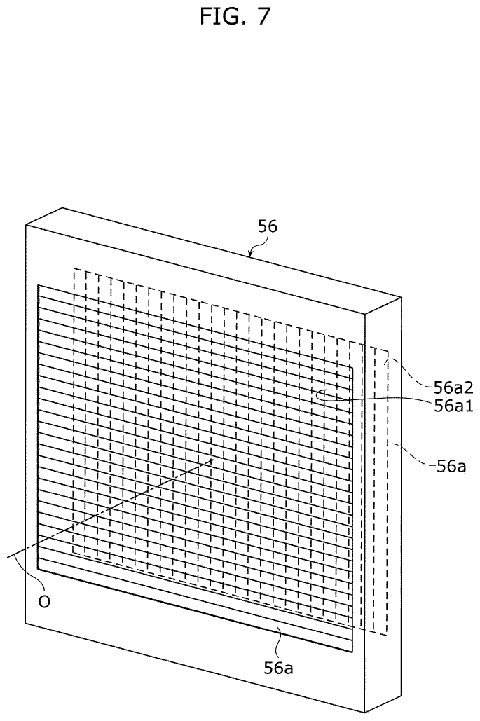

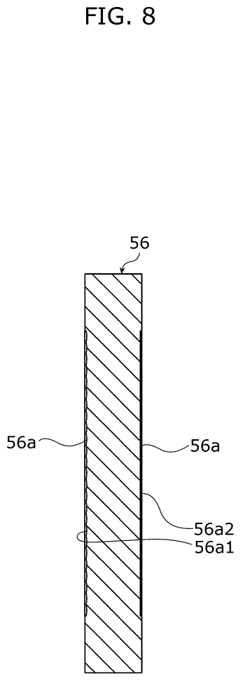

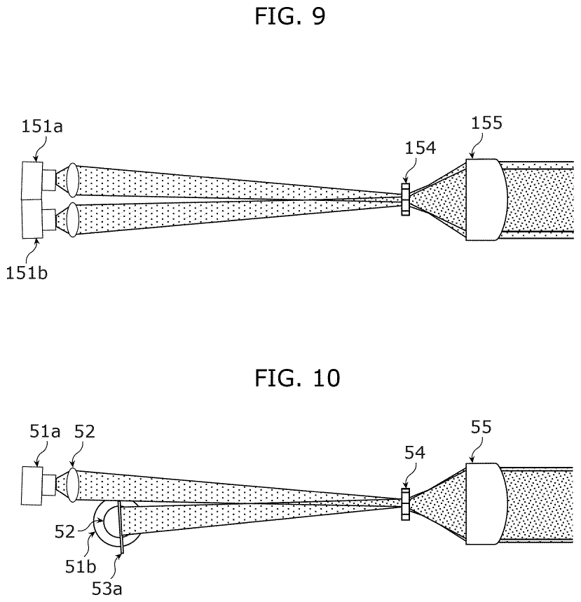

FIG. 1A is a schematic diagram showing an example of vehicle 2 in which display device 1 according to an embodiment is installed. FIG. 1B is a schematic diagram showing display device 1 according to the embodiment and vehicle 2 when viewed from the right direction. FIG. 2 is a perspective view showing display device 1 according to the embodiment. FIG. 3 is a diagram showing display device 1 according to the embodiment. (a) in FIG. 3 is a front view of display device 1, (b) in FIG. 3 is a sectional view of display device 1 taken along line B-B in (a) in FIG. 3, and (c) in FIG. 3 is a sectional view of display device 1 taken along line C-C in (a) in FIG. 3. FIG. 4 is a diagram showing the internal configuration of light emitter 50. In FIG. 4, the emitted light beams are shown by a solid line, a broken line, and a dashed-dotted line in order to show the state of the light. FIG. 5 is a perspective view showing first optical body 54. FIG. 6 is a side view showing first lens 54a of first optical body 54. FIG. 7 is a perspective view showing second optical body 56. FIG. 8 is a sectional view showing second optical body 56. FIG. 9 is a diagram showing the state of light emitted from first optical body 154 when first light source 151a and second light source 151b are arranged side by side. FIG. 10 is another diagram showing the state of light emitted from first optical body 54 in the case where the direction of light emitted by first light source 51a and the direction of light emitted by second light source 51b are different.

As shown in FIG. 1A and FIG. 1B, display device 1 is arranged, for example, on a dashboard (also referred to as an instrument panel) of vehicle 2 such as an automobile. Front window 3 (also referred to as a front shield) is arranged above the dashboard of vehicle 2. Light guide plate 30 of display device 1 is arranged between the dashboard and front window 3. Light guide plate 30 can emit image light toward front window 3. The specific configuration of light guide plate 30 will be described later.

Display device 1 can reflect the image light emitted from light guide plate 30 back to front window 3 for the user, who is the driver or a passenger, etc., so that the image light can enter the driver's eyes. That is, display device 1 can display a virtual image corresponding to the image on front window 3 by projecting the image shown by the image light emitted by light emitter 50 in front of front window 3. The image light is light that shows an image, and is light that displays a virtual image in front of front window 3. The image is a still image or a moving image, and is an image showing numbers, characters, figures, and the like.

As shown in FIG. 2 and (a) in FIG. 3, display device 1 includes light guide plate 30 and light emitter 50.

Light guide plate 30 is a hologram light guide body that displays an image shown by the image light to the user. Light guide plate 30 has a light transparency and can emit an image shown in the image light emitted by light emitter 50 by stretching it in the X-axis direction and the Y-axis direction. Light guide plate 30 is arranged to face light emitter 50 and front window 3.

Light guide plate 30 is in a rectangular shape. Light guide plate 30 is arranged in vehicle 2 in FIG. 1A and FIG. 1B so as to face light emitter 50 and front window 3.

As shown in (a) and (b) in FIG. 3, light guide plate 30 is formed with incident surface 31a and emitting surface 31b.

Incident surface 31a is arranged to face the emitting surface of light emitter 50. The image light emitted from the emitting surface of light emitter 50 is incident on incident surface 31a. Incident surface 31a is a part of the back surface of rectangular light guide plate 30. The back surface is the surface of light guide plate 30 opposite to emitting surface 31b.

Emitting surface 31b emits the image light, which was incident from incident surface 31a and propagated inside light guide plate 30, toward front window 3. Emitting surface 31b faces front window 3 and is separated from front window 3 by a predetermined distance. Emitting surface 31b is a part of the surface of light guide plate 30.

As shown in FIG. 2 and (a) in FIG. 3, light guide plate 30 includes light guide 31 having a light transparency and optical element 40.

Light guide 31 is formed with incident surface 31a that faces light emitter 50. Incident surface 31a is a part of the back surface of light guide 31. In addition, light guide 31 is formed with emitting surface 31b so as to face front window 3. Emitting surface 31b is a part of the surface of light guide 31.

Light guide 31 comprises a material having a light transparency such as glass and resin material, for example.

Light guide 31 includes optical elements 40. Optical elements 40 are light transmission type hologram elements that diffract and emit light propagating within light guide 31. Optical elements 40 are included in light guide 31 with an orientation substantially parallel to the incident surface and the emitting surface of light guide 31. Optical elements 40 comprise a material having a light transparency.

Such optical elements 40 include incident optical element 41, folding optical element 42, and emitting optical element 43. Incident optical element 41 is an example of a hologram element. Folding optical element 42 and emitting optical element 43 may also be examples of hologram elements.

Incident optical element 41 and folding optical element 42 are arranged side by side in the X-axis direction. Folding optical element 42 and emitting optical element 43 are arranged side by side in the Y-axis direction. In addition, incident optical element 41 is arranged so as to overlap incident surface 31a of light guide plate 30 when viewed in the Z-axis direction and overlap the emitting surface of image light emitter 50 arranged on the negative side in the Z-axis direction of light guide plate 30.

Incident optical element 41 is in a rectangular plate shape. Image light having a rectangular contour that is emitted from the emitting surface of light emitter 50 and travels in the Z-axis plus direction is incident on incident optical element 41. Incident optical element 41 emits the incident image light toward folding optical element 42. Specifically, incident optical element 41 emits the first image light, which is obtained by deflecting the image light which is image light from image light emitter 50 and is incident from incident surface 31a which is the image light of light emitter 50 and is obtained by deflecting the image light incident from incident surface 31a, toward folding optical element 42. More specifically, when the image light incident on light guide plate 30 propagates inside light guide plate 30, incident optical element 41 deflects the image light through diffraction according to the diffraction efficiency of incident optical element 41, and emits the image light as the first image light propagating in the X-axis plus direction. The first image light deflected through diffraction at incident optical element 41 is incident on folding optical element 42.

Folding optical element 42 is arranged on the positive side in the X-axis direction of incident optical element 41 and on the light emission side of incident optical element 41, and is arranged on the positive side in the Y-axis direction of emitting optical element 43 and on the light incident side of emitting optical element 43.

Folding optical element 42 is in a long rectangular plate shape in the X-axis direction. The rectangular first image light emitted from incident optical element 41 is incident on folding optical element 42. Folding optical element 42 further deflects through diffraction the first image light deflected through diffraction by incident optical element 41, and emits the deflected second image light. Specifically, each time the first image light that has passed through incident optical element 41 is incident (transmitted), folding optical element 42 emits the second image light obtained by further deflecting the incident first image light through diffraction toward emitting optical element 43. More specifically, when the first image light incident on folding optical element 42 propagates within light guide plate 30 in the X-axis plus direction, folding optical element 42 further deflects the first image light through diffraction depending on the diffraction efficiency of folding optical element 42. At this time, the image of the first image light is stretched in the X-axis direction by folding optical element 42. Accordingly, folding optical element 42 emits the second image light stretched in the X-axis direction in the Y-axis minus direction. The second image light deflected through diffraction at folding optical element 42 is incident on emitting optical element 43.

Emitting optical element 43 is arranged on the negative side in the Y-axis direction of folding optical element 42 and to face the light incident side of folding optical element 42. In addition, emitting optical element 43 is arranged so as to overlap and face emitting surface 31b of light guide plate 30.

Emitting optical element 43 is in a rectangular shape when viewed in the Z-axis direction. The rectangular second image light emitted from folding optical element 42 is incident on emitting optical element 43. Emitting optical element 43 further deflects through diffraction the second image light deflected through diffraction by folding optical element 42, and emits the deflected third image light to the outside of light guide plate 30. Specifically, each time the second image light that has passed through folding optical element 42 is incident (transmitted), emitting optical element 43 emits the third image light obtained by further deflecting the incident second image light through diffraction at a predetermined emission angle. More specifically, when the second image light deflected by folding optical element 42 through diffraction propagates within light guide plate 30 in the Y-axis minus direction, emitting optical element 43 further deflects the second image light through diffraction depending on the diffraction efficiency of emitting optical element 43. At this time, the image of the second image light that has been stretched in the X-axis direction is further stretched by emitting optical element 43 substantially in the Y-axis direction. Accordingly, emitting optical element 43 emits the third image light stretched in the X-axis direction and substantially the Y-axis direction to the outside of light guide plate 30 at a predetermined emission angle. That is, emitting optical element 43 further stretches the second image light emitted by folding optical element 42 approximately in the Y-axis direction, thereby emitting the third image light expanded in the X-axis direction and the Y-axis direction at a predetermined emission angle. In the present embodiment, emitting optical element 43 emits the third image light in the Z-axis plus direction toward front window 3.

Here, the predetermined emission angle is the emission angle of the third image light emitted from the emission surface of emitting optical element 43, and is the angle of the emitted light with respect to the normal to the emission surface of emitting optical element 43.

In addition, emitting optical element 43 may diverge the image light to be emitted so that the third image light has different emission angles. Emitting optical element 43 may make the emission angles different from one another depending on the position (portion) on emitting optical element 43 when the incident image light is deflected through diffraction. Accordingly, emitting optical element 43 can make the emission angles of some image light beams out of the image light beams deflected by emitting optical element 43 through diffraction different from one another.

As shown in FIG. 1B and FIG. 4, light emitter 50 is an image generating device that emits image light (an example of light) to light guide plate 30. Light emitter 50 can emit image light from a rectangular emitting surface. A predetermined image is projected onto front window 3 via light guide plate 30 by light emitter 50 emitting image light representing a rectangular image. Accordingly, the virtual image is recognized by the user.

Specifically, as shown in FIG. 4, light emitter 50 includes a plurality of light sources 51, a plurality of reflectors 53, a plurality of lenses 52, first optical body 54, collimating lens 55, second optical body 56, image display element 59, and polarizing beam splitter 58.

The plurality of light sources 51 are laser light sources that emit light beams which are in different predetermined wavelength bands from one another. In the present embodiment, as an example of the plurality of light sources 51, first light source 51a, second light source 51b, and third light source 51c are provided. For example, first light source 51a can emit blue light. Second light source 51b can emit green light. Third light source 51c can emit red light.

Third light source 51c of the present embodiment is arranged near first optical body 54 so that red light is incident on first optical body 54 over a short distance. This is because red light has a smaller light output than green light and blue light, so third light source 51c is arranged near first optical body 54 in order to ensure the output of the red light.

First light source 51a emits a light beam toward first optical body 54. Second light source 51b emits a light beam in a direction different from the direction toward first optical body 54. Third light source 51c emits a light beam in a direction different from the direction toward first optical body 54. That is, the direction of light beam emitted by first light source 51a is different from the directions of light beams emitted by second light source 51b and third light source 51c. In the present embodiment, the directions of the light beams emitted by second light source 51b and third light source 51c are the same direction.

The light beams emitted from the plurality of light sources 51 are focused by a plurality of lenses 52 that correspond one-to-one with the plurality of light sources 51, respectively. That is, the plurality of lenses 52 are arranged in the emission directions of the light beams emitted by the plurality of light sources 51 so as to correspond one-to-one with the plurality of light sources 51, respectively. The light beam focused by the plurality of lenses 52 is incident on each of the plurality of reflectors 53.

The plurality of reflectors 53 are arranged on the light beams emitted by the plurality of light sources 51, respectively, and can reflect the light beams in a predetermined wavelength band and transmit the light beams in other wavelength bands. Reflectors 53 are, for example, dichroic mirrors having wavelength selectivity. The plurality of reflectors 53 may have different wavelength selectivities from one another.

In the present embodiment, as an example of the plurality of reflectors 53, first reflector 53a, second reflector 53b, and third reflector 53c are provided. In the present embodiment, third reflector 53c, second reflector 53b, first reflector 53a, and first light source 51a are arranged in the stated order from the side of first optical body 54.

Second reflector 53b is arranged to face third light source 51c. Second reflector 53b has the property of reflecting red light (light with a red wavelength component) and transmitting light other than red light. For this reason, second reflector 53b reflects the red light emitted by third light source 51c toward first optical body 54.

First reflector 53a is arranged to face second light source 51b and first light source 51a. Specifically, first reflector 53a is arranged such that one surface of first reflector 53a faces second light source 51b, and the other surface of first reflector 53a faces first light source 51a.

First reflector 53a has the property of reflecting green light (light with a green wavelength component). For this reason, first reflector 53a reflects the green light emitted by second light source 51b toward second reflector 53b, that is, toward first optical body 54.

In addition, first reflector 53a also has the property of transmitting light other than green light. For this reason, first reflector 53a transmits the blue light emitted by first light source 51a and emits it toward second reflector 53b.

For example, third reflector 53c may have the property of transmitting red light, green light, and blue light and reflecting light other than red light, green light, and blue light. For this reason, third reflector 53c may transmit light in a plurality of wavelength bands, such as red light, green light, and blue light emitted by third light source 51c, second light source 51b, and first light source 51a, toward first optical body 54. It should be noted that third reflector 53c may not be provided in light emitter 50.

As shown in FIG. 4 and FIG. 5, first optical body 54 is arranged between third reflector 53c and collimating lens 55. The light that has passed through third reflector 53c is incident on first optical body 54. First optical body 54 is capable of adjusting the contour of the incident light and emitting it. The contour of light indicates the shape of light when a virtual plane is irradiated with light. In the present embodiment, first optical body 54 can adjust the contour of the light that has passed through third reflector 53c and emit the light having a rectangular contour toward collimating lens 55.

First optical body 54 is, for example, a microlens array or a lenticular lens. First optical body 54 includes a plurality of first lenses 54a that can adjust the contour of the light emitted by light source 51. Specifically, each of the plurality of first lenses 54a is in a prismatic shape, and is long in the direction of light incident on first optical body 54, in other words, in the direction of the principal light transmitted through third reflector 53c. First optical body 54 is configured by integrating a plurality of first lenses 54a arranged in a matrix shape. It should be noted that in the present embodiment, each of the plurality of first lenses 54a is exemplified as being in a quadrangular prism shape, but if it is possible to arrange them in a matrix shape without gaps, other polygonal prisms may also be used for first optical body 54.

The outline of each of the plurality of first lenses 54a is analogous to the shape of incident optical element 41 (hologram element). Analogous in the present embodiment means that the outline of first lens 54a is identical or similar to the shape of incident optical element 41. The outline of each of the plurality of first lenses 54a is a shape when viewed facing first incident surface 54a1 or first emitting surface 54a2. For example, if incident optical element 41 is in a polygonal shape, the shape represented by first lens 54a is also in a polygonal shape. In the present embodiment, the outline of each of the plurality of first lenses 54a is in a rectangular shape corresponding to the shape of incident optical element 41.

Each of the plurality of first lenses 54a includes first incident surface 54a1 and first emitting surface 54a2 which is a surface on the opposite side of first incident surface 54a1.

At least one of first incident surface 54a1 or first emitting surface 54a2 is curved in a concave or convex shape. FIG. 6 of the present embodiment illustrates a case where first incident surface 54a1 is curved in a convex shape and first emitting surface 54a2 is a flat surface. It should be noted that one of first incident surface 54a1 and first emitting surface 54a2 may be curved in a concave or convex shape, and the other may be a flat surface.

As shown in FIG. 4 and FIG. 5, first incident surface 54a1 faces third reflector 53c. For this reason, the light that has passed through third reflector 53c is incident on first incident surface 54a1. First emitting surface 54a2 faces collimating lens 55. For this reason, first emitting surface 54a2 emits the light incident from first incident surface 54a1 toward collimating lens 55.

Because of such a configuration, each of the plurality of first lenses 54a can adjust the contour of the light transmitted through third reflector 53c and emit light with a rectangular contour. In addition, since each of the plurality of first lenses 54a is in a prismatic shape, it is possible to emit top hat-shaped light (light with suppressed luminance unevenness) that makes the emitted light uniform. As mentioned above, first optical body 54 can emit light that is uniform and has a rectangular contour.

Collimating lens 55 is arranged between first optical body 54 and second optical body 56. The light emitted from first optical body 54 is incident on collimating lens 55, and the incident light can be collimated and emitted toward second optical body 56.

As shown in FIG. 4 and FIG. 7, second optical body 56 is arranged between collimating lens 55 and polarizing beam splitter 58. The light emitted from collimating lens 55 is incident on second optical body 56, which can emit the incident light after adjusting the contour of the incident light. In the present embodiment, second optical body 56 can adjust the contour of the light transmitted through collimating lens 55 and emit the light having a rectangular contour toward polarizing beam splitter 58.

Second optical body 56 is, for example, a microlens array or a lenticular lens. Second optical body 56 includes a plurality of second lenses 56a that can further adjust the contour of the light emitted by first optical body 54. Specifically, the plurality of second lenses 56a are a plurality of grooves extending in a direction perpendicular to central axis O of second optical body 56. It should be noted that the direction in which each of the plurality of grooves extends may be, for example, either the vertical direction or the horizontal direction.

The overall outline represented by the plurality of second lenses 56a is analogous to the shape of incident optical element 41. Analogous in the present embodiment means that the overall outline represented by second lens 56a is identical or similar to the shape of incident optical element 41. The outline (shape) represented by second optical body 56 is a shape viewed in central axis O, and is analogous to the shape of incident optical element 41. For example, if incident optical element 41 is in a polygonal shape, the overall outline represented by the plurality of second lenses 56a is also in a polygonal shape. In the present embodiment, the overall outline represented by the plurality of second lenses 56a is in a rectangular shape corresponding to the shape of incident optical element 41.

Second optical body 56 includes second incident surface 56a1 and second emitting surface 56a2 which is a surface opposite to second incident surface 56a1.

A plurality of second lenses 56a are formed on at least one of second incident surface 56a1 or second emitting surface 56a2. In FIG. 8 of the present embodiment, the plurality of second lenses 56a are formed on parts of second incident surface 56a1 and second emitting surface 56a2. In addition, the direction in which each of the plurality of second lenses 56a formed on second incident surface 56a1 extends may be perpendicular to the direction in which each of the plurality of second lenses 56a formed on second emitting surface 56a2 extends.

As shown in FIG. 4 and FIG. 7, second incident surface 56a1 faces collimating lens 55. For this reason, the light emitted from collimating lens 55 is incident on second incident surface 56a1. Second emitting surface 56a2 faces polarizing beam splitter 58. For this reason, second emitting surface 56a2 emits the light incident from second incident surface 56a1 toward polarizing beam splitter 58 via field lens 57a. Field lens 57a focuses the light emitted by second optical body 56 and emits it to polarizing beam splitter 58.

Because of this configuration, second optical body 56 can adjust the contour of the light that has passed through collimating lens 55 and emit the light with a rectangular contour toward the side of polarizing beam splitter 58.

The light having the contour adjusted by second optical body 56 is incident on polarizing beam splitter 58. Polarizing beam splitter 58 reflects the light emitted by second optical body 56 toward image display element 59 and causes the light to be incident on image display element 59. Specifically, image display element 59 is, for example, a liquid crystal display element such as liquid crystal on silicon (LCOS), and is irradiated with light in a plurality of wavelength bands from polarizing beam splitter 58. Then, image display element 59 emits the irradiated light as image light toward incident optical element 41 via polarizing beam splitter 58 and projection lens 57b.

Projection lens 57b focuses the image light emitted by image display element 59 and passes through polarizing beam splitter 58, and emits the image light to the incident surface of light guide plate 30. The image light incident on the incident surface of light guide plate 30 is incident on incident optical element 41 that serves as a pupil surface. In this way, the light having the contour adjusted by first optical body 54 and second optical body 56 so as to have a shape analogous to the shape of incident optical element 41 is incident on incident optical element 41 as image light.

### <Working Effects>

The working effects of such display device 1 in the present embodiment will be described.

In the virtual image projection device of PTL 1, for example, there is such a problem that when the shape of the image light that the projector allows to be incident on the light guide is different from the shape of the pupil incident surface of the light guide, the light utilization efficiency may decrease.

Therefore, as described above, display device 1 of the present embodiment includes light guide plate 30 including a hologram element (incident optical element 41) and light emitter 50 that emits light to light guide plate 30. In addition, light emitter 50 includes light source 51 that emits the light, and first optical body 54 including a plurality of first lenses 54a capable of adjusting a contour of the light emitted by light source 51. An outline of each of the plurality of first lenses 54a is analogous to a shape of the hologram element.

According to this, each of the plurality of first lenses 54a can adjust the contour of the light emitted by light source 51 to be analogous to the shape of incident optical element 41. For this reason, the light emitted by light source 51 can be utilized as much as possible.

Therefore, in display device 1, a decrease in light utilization efficiency can be suppressed.

In addition, in display device 1 of the present embodiment, each of the plurality of first lenses 54a is in a prismatic shape. First optical body 54 is configured by integrating the plurality of first lenses 54a.

According to this, each of the plurality of prismatic first lenses 54a can emit light with further uniform luminance. For this reason, each of the plurality of first lenses 54a can emit light with an adjusted contour and uniform luminance. As a result, it is possible to suppress a decrease in light utilization efficiency and suppress unevenness of light emitted by display device 1.

In addition, in display device 1 of the present embodiment, first optical body 54 is a microlens array or a lenticular lens.

According to this, it is possible to suppress a decrease in light utilization efficiency in display device 1, to emit light with suppressed luminance unevenness, and to emit light with suppressed generation of speckles.

In addition, in display device 1 of the present embodiment, light emitter 50 includes second optical body 56 including a plurality of second lenses 56a capable of adjusting a contour of the light emitted by each of the plurality of first lenses 54a. In addition, an overall outline represented by the plurality of second lenses 56a is analogous to the shape of the hologram element. The light having the contour adjusted by second optical body 56 is incident on the hologram element.

According to this, second optical body 56 can adjust the contour of the light emitted by light source 51 to be analogous to the shape of incident optical element 41. For this reason, the light emitted by light source 51 can be utilized as much as possible.

Therefore, in display device 1, a decrease in light utilization efficiency can be further suppressed.

In addition, in display device 1 of the present embodiment, the plurality of second lenses 56a are a plurality of grooves extending in a direction perpendicular to central axis O of second optical body 56. An overall outline represented by the plurality of grooves is in a rectangular shape.

According to this, it is possible to further suppress the occurrence of speckles (luminance unevenness) in the light emitted from second optical body 56. For this reason, entire second optical body 56 can emit light with an adjusted contour and suppressed generation of speckles. As a result, it is possible to suppress a decrease in light utilization efficiency and suppress unevenness of light emitted by display device 1.

In addition, in display device 1 of the present embodiment, the hologram element is in a rectangular shape. In addition, the outline of each of the plurality of first lenses 54a is in the rectangular shape corresponding to the shape of the hologram element. The overall outline represented by the plurality of second lenses 56a is in a rectangular shape corresponding to a shape of first optical body 54.

According to this, since the outline of each of the plurality of first lenses 54a and the overall outline represented by the plurality of second lenses 56a is in a shape analogous to the shape of the hologram element, it is possible to allow light corresponding to the size and shape of incident optical element 41 to be incident. For this reason, in display device 1, a decrease in light utilization efficiency can be further suppressed.

In addition, in display device 1 of the present embodiment, second optical body 56 is a microlens array or a lenticular lens.

According to this, it is possible to suppress a decrease in light utilization efficiency in display device 1, to emit light with suppressed luminance unevenness, and to emit light with suppressed generation of speckles.

In addition, in display device 1 of the present embodiment, light source 51 includes first light source 51a that emits light toward first optical body 54, and second light source 51b that emits light in a direction different from a direction toward first optical body 54. Light emitter 50 further includes first reflector 53a that reflects the light emitted by second light source 51b toward first optical body 54. The light emitted by first light source 51a and the light emitted by second light source 51b and reflected by first reflector 53a are incident on an incident surface of first optical body 54 in an overlapping manner.

For example, as shown in FIG. 9, when first light source 151a and second light source 151b are configured to emit light toward first optical body 154, the angle between the direction of the light emitted by first light source 151a and the direction of the light emitted by second light source 151b needs to be made as small as possible to prevent unevenness in the light emitted after being multiplexed by first optical body 154. For this reason, first light source 151a and second light source 151b may be arranged close to each other. However, when a high-output light source is required, the light source (for example, an LED package) becomes larger, so the above angle becomes larger, and the light that is emitted after being multiplexed by first optical body 154 and incident on collimating lens 155 is likely to become uneven. For this reason, in the light emitted from first optical body 154, there will be a darkly hatched part where the light emitted by first light source 151a and the light emitted by second light source 151b overlap, and a thinly hatched part where the two lights do not overlap. In addition, since first light source 51a and second light source 51b are close to each other, a problem arises in terms of heat dissipation of the display device.

However, in the present embodiment, as shown in FIG. 10, the direction of the light emitted by first light source 51a and the direction of the light emitted by second light source 51b are arranged to be different, and first reflector 53a that reflects the light emitted by second light source 51b toward first optical body 54 is used. For this reason, the angle between the direction of the light emitted by first light source 51a that is incident on first optical body 54 and the direction of the light emitted by second light source 51b that is incident on second optical body 56 can be made as small as possible. Accordingly, most of the light emitted by first light source 51a and the light emitted by second light source 51b can be superimposed and be incident on first optical body 54. As a result, since the light can be efficiently multiplexed, light with more suppressed luminance unevenness can be emitted from first optical body 54 and made to be incident on collimating lens 55.

In addition, since first light source 51a and second light source 51b can be placed at separate positions, it is possible to suppress a decrease in heat dissipation in display device 1.

In addition, in display device 1 of the present embodiment, light source 51 further includes third light source 51c that emits light in a direction different from a direction toward first optical body 54. Light emitter 50 further includes: second reflector 53b that reflects the light emitted by third light source 51c toward first optical body 54; collimating lens 55 that collimates the light emitted by first optical body 54; second optical body 56 including a plurality of second lenses 56a capable of adjusting a contour of light emitted by collimating lens 55; polarizing beam splitter 58 on which the light having the contour adjusted by second optical body 56 is incident; and image display element 59 that reflects the light that has passed through polarizing beam splitter 58 toward the hologram element.

According to this, first optical body 54 can adjust the contour of the light emitted by light source 51 to be analogous to the shape of incident optical element 41. For this reason, the light emitted by light source 51 can be utilized as much as possible.

Therefore, in display device 1, a decrease in light utilization efficiency can be suppressed.

### (Other Variations, Etc.)

Although the present disclosure has been described above based on the embodiment, the present disclosure is not limited to the embodiment.

For example, in the display device of the embodiment, the first light source may emit blue light, the second light source may emit green light, and the third light source may emit red light. In this case, since the third light source is far away from the first optical body, the display device may have two third light sources. At this time, the two third light sources may be arranged as shown in FIG. 10.

In addition, forms obtained by applying various modifications to the embodiment conceived by a person skilled in the art or forms realized by arbitrarily combining the components and functions in the embodiment without departing from the spirit of the present disclosure are also included in this disclosure.

### (Additional Note)

The characteristics of the display device described based on the above embodiment are shown below.

### <Technology 1>

A display device comprising:
a light guide plate including a hologram element; and
a light emitter that emits light to the light guide plate,
wherein the light emitter includes:
   a light source that emits light; and
   a first optical body including a plurality of first lenses capable of adjusting a contour of the light emitted by the light source, and
   an outline of each of the plurality of first lenses is analogous to a shape of the hologram element.

### <Technology 2>

The display device according to technology 1,
wherein each of the plurality of first lenses is in a prismatic shape, and
the first optical body is configured by integrating the plurality of the first lenses.

### <Technology 3>

The display device according to technology 1,
wherein the first optical body is a microlens array or a lenticular lens.

### <Technology 4>

The display device according to technology 1 or 2,
wherein the light emitter includes a second optical body including a plurality of second lenses capable of adjusting a contour of the light emitted by the first optical body,
an overall outline represented by the plurality of second lenses is analogous to the shape of the hologram element, and
the light having the contour adjusted by the second optical body is incident on the hologram element.

### <Technology 5>

The display device according to technology 4,
wherein the plurality of second lenses are a plurality of grooves extending in a direction perpendicular to a central axis of the second optical body, and
an overall outline represented by the plurality of grooves is in a rectangular shape.

### <Technology 6>

The display device according to technology 4 or 5,
wherein the hologram element is in a rectangular shape,
the outline of each of the plurality of first lenses is in the rectangular shape corresponding to the shape of the hologram element, and
the overall outline represented by the plurality of second lenses is in a rectangular shape corresponding to a shape of the first optical body.

### <Technology 7>

The display device according to any one of technology 4 to 6,
wherein the second optical body is a microlens array or a lenticular lens.

### <Technology 8>

The display device according to any one of technology 1 to 7,
wherein the light source includes a first light source that emits light toward the first optical body, and a second light source that emits light in a direction different from a direction toward the first optical body,
the light emitter further includes a first reflector that reflects the light emitted by the second light source toward the first optical body, and
the light emitted by the first light source and the light emitted by the second light source and reflected by the first reflector are incident on an incident surface of the first optical body in an overlapping manner.

### <Technology 9>

The display device according to any one of technology 1 to 8,
wherein the light source further includes a third light source that emits light in a direction different from a direction toward the first optical body, and
the light emitter further includes:
   a second reflector that reflects the light emitted by the third light source toward the first optical body;
   a collimating lens that collimates the light emitted by the first optical body;
   a second optical body including a plurality of second lenses capable of adjusting a contour of light emitted by the collimating lens;
   a polarizing beam splitter on which the light having the contour adjusted by the second optical body is incident; and
   an image display element that reflects the light that has passed through the polarizing beam splitter toward the hologram element.

While various embodiments have been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims are incorporated herein by reference in their entirety: Japanese Patent Application No. 2023-057601 filed on Mar. 31, 2023.

### INDUSTRIAL APPLICABILITY

The present disclosure can be used in a display device such as a head-up display device of a vehicle.

1. A display device comprising:
a light guide plate including a hologram element; and
a light emitter that emits light to the light guide plate,
wherein the light emitter includes:
a light source that emits light; and
a first optical body including a plurality of first lenses capable of adjusting a contour of the light emitted by the light source, and
an outline of each of the plurality of first lenses is analogous to a shape of the hologram element.

2. The display device according to claim 1,
wherein each of the plurality of first lenses is in a prismatic shape, and
the first optical body is configured by integrating the plurality of the first lenses.

3. The display device according to claim 1,
wherein the first optical body is a microlens array or a lenticular lens.

4. The display device according to claim 1,
wherein the light emitter includes a second optical body including a plurality of second lenses capable of adjusting a contour of the light emitted by the first optical body,
an overall outline represented by the plurality of second lenses is analogous to the shape of the hologram element, and
the light having the contour adjusted by the second optical body is incident on the hologram element.

5. The display device according to claim 4,
wherein the plurality of second lenses are a plurality of grooves extending in a direction perpendicular to a central axis of the second optical body, and
an overall outline represented by the plurality of grooves is in a rectangular shape.

6. The display device according to claim 4,
wherein the hologram element is in a rectangular shape,
the outline represented by each of the plurality of first lenses is in the rectangular shape corresponding to the shape of the hologram element, and
the overall outline represented by the plurality of second lenses is in a rectangular shape corresponding to a shape of the first optical body.

7. The display device according to claim 4,
wherein the second optical body is a microlens array or a lenticular lens.

8. The display device according to claim 1,
wherein the light source includes a first light source that emits light toward the first optical body, and a second light source that emits light in a direction different from a direction toward the first optical body,
the light emitter further includes a first reflector that reflects the light emitted by the second light source toward the first optical body, and
the light emitted by the first light source and the light emitted by the second light source and reflected by the first reflector are incident on an incident surface of the first optical body in an overlapping manner.

9. The display device according to claim 1,
wherein the light source further includes a third light source that emits light in a direction different from a direction toward the first optical body, and
the light emitter further includes:
a second reflector that reflects the light emitted by the third light source toward the first optical body;
a collimating lens that collimates the light emitted by the first optical body;
a second optical body including a plurality of second lenses capable of adjusting a contour of light emitted by the collimating lens;
a polarizing beam splitter on which the light having the contour adjusted by the second optical body is incident; and
an image display element that reflects the light that has passed through the polarizing beam splitter toward the hologram element.
